(19) United States
(12) Patent Application Publication
(10) Pub. No.: US 2011/0284347 A1
(43) Pub. Date: Nov. 24, 2011

(54) METAL-FUSED PLASTIC CONVEYOR BELT COMPONENTS AND METHODS OF MAKING

(75) Inventors: Gilbert J. MacLachlan, Harahan, LA (US); David C. Weiser, River Ridge, LA (US)

(73) Assignee: LAITRAM, L.L.C., Harahan, LA (US)

(21) Appl. No.: 13/141,112

(22) PCT Filed: Jan. 11, 2010
(86) PCT No.: PCT/US10/20586

§ 371 Date: Jun. 21, 2011

Related U.S. Application Data
(60) Provisional application No. 61/143,860, filed on Jan. 12, 2009.

(51) Int. Cl. B65G 17/06; B29C 47/00

(52) U.S. Cl. 198/851; 198/844.1; 264/129

(57) ABSTRACT

Metal-coated thermo-plastic conveyor belt components and methods for their manufacture. Hinge rods, sprockets, and belt modules are coated with metal to increase their stiffness or wear resistance or to improve other performance characteristics.

### BACKGROUND

The invention relates to modular plastic conveyor belt components covered with a metal coating.

Spiral belt conveyors are often used to convey products slowly through ovens, proofers, or freezers. Most spiral conveyors use metal belts with large open areas to transport products along a helical conveying path around a slowly rotating spiral drive tower. Because metal belts are inherently stiff, only a few rails below the belt are needed to support it. Lightweight, corrosion-resistant modular plastic conveyor belts are replacing metal belts in some spiral applications. In some retrofit situations, a plastic belt can be mounted directly on the existing spiral conveyor's support rails. But the beam stiffness of modular plastic conveyor belts across the belt's width is not so high as the beam stiffness of metal belts. Solid stainless steel hinge rods are often used to add beam stiffness to plastic belts. But solid metal rods add weight to the belt and, because of their stiffness, limit load-sharing to only the first couple of hinge elements at the outer side edge of the belt.

Besides these problems specific to spiral belts, modular plastic conveyor belts are subject to wear at hinges and at drive surfaces where there is rubbing between the hinge eyes and hinge pins and between sprocket teeth and drive surfaces on the belts.

### SUMMARY

These shortcomings and others are overcome by conveyor belt components embodying features of the invention. Such components comprise a thermoplastic member adapted for use with a modular conveyor belt and having an outer surface covered, at least in part, by a metal coating.

In another aspect of the invention, a method of making such a conveyor belt component comprises forming a thermoplastic member with an outer surface and adapted for use with a modular conveyor belt and covering at least a portion of the outer surface with a metal coating.

### BRIEF DESCRIPTION OF THE DRAWINGS

These features and aspects of the invention, as well as its advantages, are better understood by referring to the following description, appended claims, and accompanying drawings, in which:

FIG. 1 is a top plan view of a portion of a spiral conveyor belt having hinge rods embodying features of the invention;

FIG. 2 is an enlarged cross-section of the hinge rod of FIG. 1 taken along lines 2-2;

FIG. 3 is a side view of a sprocket embodying features of the invention; and

FIG. 4 is an oblique view of a portion of a conveyor belt module embodying features of the invention.

### DETAILED DESCRIPTION

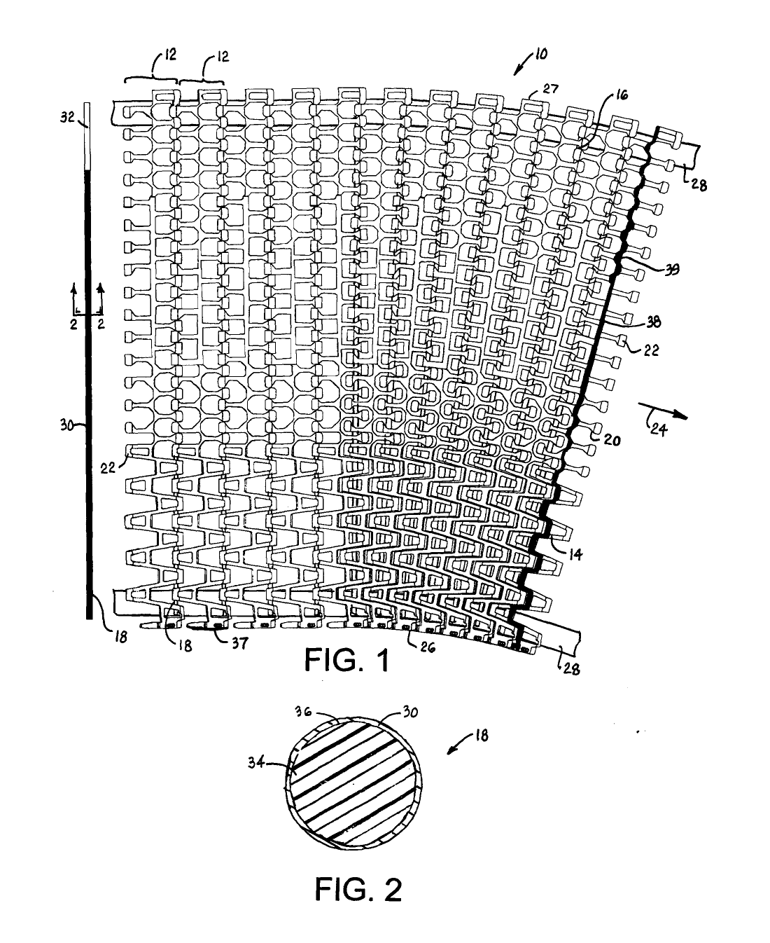

FIG. 1 shows a portion of a modular plastic conveyor belt interconnected by hinge rods embodying features of the invention. The belt 10, which is suitable for traveling a helical path such as around a spiral conveyor's drive tower, comprises a series of rows 12 of one or more belt modules 14 connected together at hinge joints 16 by hinge rods 18. Holes 20 through laterally spaced hinge elements, or eyes 22, along a leading end of each row are aligned with holes through the interleaved hinge elements along a trailing edge of a leading row to form a lateral passageway across the width of the belt. Hinge rods received in the passageways between adjacent rows connect the belt together and allow it to articulate around sprockets. In this particular belt, some or all of the holes 20 are elongated in the direction of belt travel 24 to allow the inside edge 26 of the belt to collapse at the inside of a turn as the outside edge 27 expands.

The belt is shown supported near the inside and outside edges by rails 28. To limit the sag of the plastic belt between the rails, some or all of the hinge rods 18 are stiffened with a metal coating 30 or cladding along all or a major portion of their lengths. The rods increase the lateral beam stiffness of the belt to limit sag. For the spiral belt in FIG. 1, the end 32 of the hinge rod at the outside edge 27 of the belt is uncoated to give the outside edge of the belt enough flexibility to share belt pull across more of the outermost hinge elements.

As shown in FIG. 2, the coated portion of the hinge rod 18 comprises an inner thermoplastic core 34 whose circular cylindrical outer surface 36 is covered by the thin metal coating 30 of uniform thickness. The core is a thermoplastic polymer, such as polypropylene, polyethylene, acetal, and nylon, formed by extrusion or molding. The metal coating is preferably a nanocrystalline metal alloy, e.g., nickel and nickel—iron alloys, fused to the polymeric core. The MetaFuse™ nanocrystalline metal/polymer hybrid technology developed by DuPont Engineering Polymers of Wilmington, Del., Morph Technologies, Inc., Integran Technologies, Inc., and PowerMetal Technologies is one technology useful in coating a thermoplastic material with a metal cladding to increase stiffness. That and other suitable metal-coating technologies are described in U.S. Pat. No. 7,354,354, “Article Comprising a Fine-Grained Metallic Material and a Polymeric Material,” Apr. 8, 2008, incorporated by reference.

Each row of the belt of FIG. 1 also has a narrow lateral beam 38 that varies in shape from generally sinusoidal to tapered to stepped from the outside edge 27 inward to the inside edge 26. Coating all or a portion of the beam with a metal coating 39 increases the beam stiffness of the belt. The inside edge of the belt could be coated in metal 37 to resist wear against the drive tower.

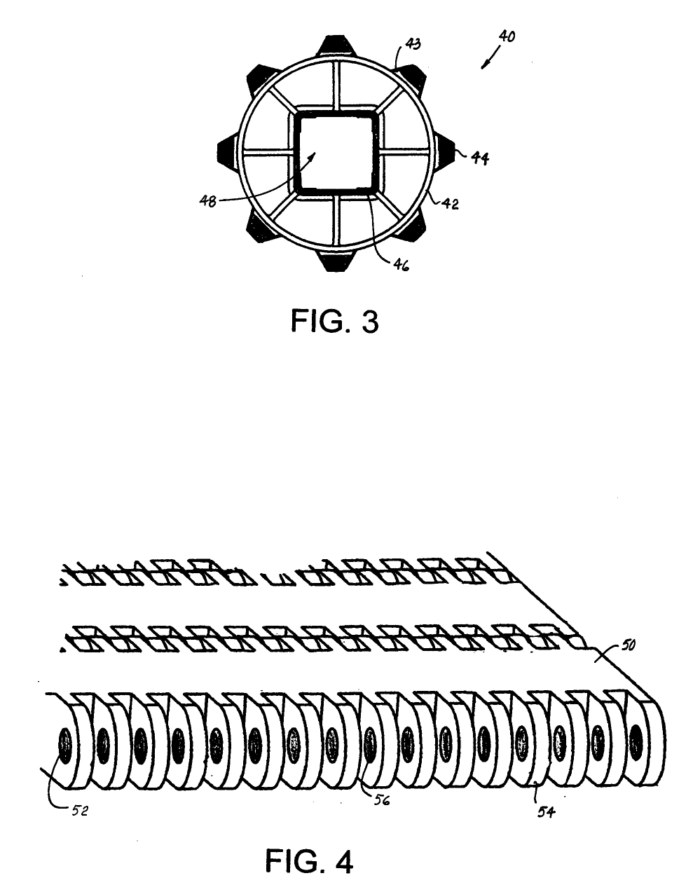

Conveyor belt components other than hinge rods may be made in a similar way to achieve these and other benefits. For example, a sprocket 40 for a modular conveyor belt is shown in FIG. 3. The sprocket comprises an injection-molded thermoplastic member 42, portions of whose outer surface are covered with a metal coating. In particular, the sprocket's drive surfaces, or teeth 43, have a metal coating 44 to decrease wear from the constant rubbing they undergo as they move into and out of contact with belt drive surfaces. A metal coating 46 is also shown bounding a central bore 48 through the sprocket. The metal coating fights wear on the bore's walls caused by the rubbing of a shaft against the walls. Thus, the metal coating is used in bearing regions that are subjected to frictional contact with other conveyor belt components.

Another example of a metal-coated thermoplastic conveyor belt component is the belt module 50 of FIG. 4. Like the sprocket of FIG. 3, the belt module is largely made of a thermoplastic polymer in an injection molding process. A portion of its outer surface—in this case, the cylindrical walls of rod holes 52 though hinge elements 54—is covered by a metal coating 56 to provide wear resistance to this bearing region of the belt module.

Although the invention has been described with reference to a few preferred versions, other versions are possible. For example, the metal-coated hinge rod was shown coated along only a portion of its length, but could be coated along its entire length. And the rod was shown with a circular cross section, but its cross section could be oval, rectangular, or even asymmetrical. Some other conveyor belt components that could benefit from metal-coating include: the top edges of flights; drive-receiving surfaces in belt modules; the bearing surfaces supporting roller balls in ball belts; holddown guides in radius, spiral, or inclined belts; axles for fixed-axis rollers in roller belts. Metal coatings can also be used to provide thermoplastic conveyor belt components with electrical conductivity, magnetic properties, visible or otherwise detectable indicia, or aesthetically pleasing designs. As another example, other metal-coating processes, such as metal deposition, electroplating, and adhesive-bonding, could be used to stiffen thermoplastic conveyor belt members. So, as these few examples suggest, the scope of the claims is not meant to be limited to the preferred versions described in detail.

What is claimed is:

1. A conveyor belt component comprising:
a thermoplastic member having an outer surface and adapted for use with a modular conveyor belt;
a metal coating covering at least a portion of the outer surface of the thermoplastic member.

2. A conveyor belt component as in claim 1 wherein the thermoplastic member comprises a hinge rod having a cylindrical outer surface between opposite ends of the rod and wherein the metal coating covers at least a portion of the cylindrical outer surface.

3. A conveyor belt component as in claim 2 wherein the metal coating covers the cylindrical outer surface inward from one end of the hinge rod.

4. A conveyor belt component as in claim 1 wherein the thermoplastic member comprises a conveyor belt module having hinge elements with holes therethrough and wherein the metal coating covers at least a portion of the outer surface of the hinge elements.

5. A conveyor belt component as in claim 4 wherein the metal coating bounds the holes.

6. A conveyor belt component as in claim 1 wherein the thermoplastic member comprises a conveyor belt module having a central beam and wherein the metal coating covers at least a portion of the outer surface of the central beam.

7. A conveyor belt component as in claim 1 wherein the thermoplastic member comprises a conveyor belt module having a side edge forming a bearing region and wherein the metal coating covers at least a portion of the side edge.

8. A conveyor belt component as in claim 1 wherein the thermoplastic member comprises a sprocket having drive surfaces and wherein the metal coating covers at least a portion of the drive surfaces.

9. A conveyor belt component as in claim 1 wherein the thermoplastic member comprises a sprocket having a central bore and wherein the metal coating on the outer surface of the sprocket bounds the bore.

10. A conveyor belt component as in claim 1 wherein the metal coating is fused to the outer surface of the thermoplastic member.

11. A conveyor belt component as in claim 1 wherein the thickness of the coating is uniform.

12. A conveyor belt component as in claim 1 comprising a bearing region in frictional contact with other components when installed in a conveyor belt, wherein the bearing region includes the metal coating.

13. A method for making a conveyor belt component, comprising:
forming a thermoplastic member with an outer surface and adapted for use with a modular conveyor belt;
covering at least a portion of the outer surface with a metal coating.

14. The method of claim 13 comprising fusing the metal coating to the outer surface of the thermoplastic conveyor belt member.

15. The method of claim 13 wherein the thermoplastic conveyor belt member is formed by extrusion.
